(19) United States
(12) Patent Application Publication
(10) Pub. No.: US 2003/0229582 A1
(43) Pub. Date: Dec. 11, 2003

(54) Method, apparatus and system for providing notifications in commercial transactions

(76) Inventors: Sanford Sherman, Laguna Niguel, CA (US); Dominic Greco, Laguna Niguel, CA (US)

Correspondence Address: Brull Piccionelli Sarno Braun & Vradenburgh, Suite 2350, 1925 Century Park East, Los Angeles, CA, 90067, US

(21) Appl. No.: 10/388,203

(22) Filed: Mar. 12, 2003

Related U.S. Application Data
(63) Continuation-in-part of application No. 10/056,241, filed on Jan. 22, 2002.

(51) Int. Cl. G06F 17/60

(52) U.S. Cl. 705/38

(57) ABSTRACT

The present invention is directed to a method, apparatus and system for controlling and assessing risk in commercial transactions. Embodiments of the present invention allow multiple participants of the risk assessment and control system to establish criteria for conducting transactions, wherein the criteria allows for the controlling and assessment of risk in future transactions, namely, the parties can preset qualifications and eligibility requirements for participation in specific types of transactions. Parties desiring to participate in transactions via the system, each independently join the system and set up participant information files and further, establish their particular criteria or filters for participation in the system. Once each participant has established its criteria for transactions, the parties can seek to conduct transactions via the system.

### RELATED APPLICATIONS

This application is a continuation-in-part of pending U.S. patent application Ser. No. 10/056,241 entitled A Method, Apparatus and System for Control and Assessment of Risk in Commercial Transactions, filed on Jan. 22, 2002, which is incorporated herein by reference.

### FIELD OF THE INVENTION

The present invention is directed to a method, apparatus and system for controlling and assessing risk in commercial transactions. More specifically, a risk control system that allows real-time management and development of loan criteria for commercial transactions via a user interface on a network and for providing of notification to the consumer.

### BACKGROUND OF THE INVENTION

Assessing the credit worthiness of consumers is an involved and complicated process entailing a plurality of factors and criteria that vary from consumer to consumer and from lender to lender. Typically, a consumer desiring a loan from a lender must apply for a loan, wherein the loan application requests various types of information, including, for example, salary, loan amount, and assets. Upon submission of the loan application, the lender requests information from a credit bureau which has a credit assessment, or credit check, on the applicant based upon the historical data of the applicant retained by the credit bureau. The credit bureau provides a credit score to the lender, wherein the score is based on a set of criteria preset by the credit bureau. The preset criteria generally does not vary and is independent of the type of loan desired by the consumer.

The score received by the credit bureau informs the lender of the consumer's perceived credit worthiness. Based upon the score alone, a consumer can be denied a loan, or be penalized with higher interest rates. Unless the underlying information changes, the credit bureau score cannot be modified by altering the factors supporting the credit evaluation. Thus, in many instances, a consumer's current credit status, as determined by the credit bureau, dictates the consumer's ability to participate in a variety of transactions.

Credit assessment is performed for a variety of consumer transactions, including for example, car purchases, credit cards, insurance assessment, and home purchases. In these types of transactions, that is, transactions wherein the consumer is not directly requesting a loan from a bank, the consumer is conducting the request for a loan through an intermediary, such as, a car dealer or loan broker. In these instances, the consumer supplies the loan information to the intermediary and the intermediary submits the information to a plurality of lending institutions that the intermediary has chosen. Each lending institution assesses the loan information independently of all other lending institutions. Thus, the assessment process is performed multiple times, that is, by each lending institution receiving the loan application. In addition, each lending institution has its own set of subjective criteria, wherein the criteria may vary slightly or substantially from institution to institution. To exacerbate the problem, if the loan requires insurance, the insurance industry reviews the loan information and the collateral supporting the loan with a completely different set of criteria, namely, criteria that assesses risk.

The processing of loan information is not only time consuming, but can often take several weeks before the applicant receives an answer. Further, if the loan application is submitted to multiple lenders, all but one of the lenders will have essentially wasted their time in the loan process as the applicant will choose to accept the best loan offered. Thus, the lending institutions waste countless hours of labor in processing information that will not result in business to the lending institution. Further still, if a lender chooses to decline a loan, pursuant to various federal laws, the lender is required to transmit a declination letter, also known as an adverse action letter, to the consumer indicating the consumer's rights regarding obtaining a consumer credit report or the reasons for the declination. Thus, a consumer may receive a plurality of declination letters indicating the same information.

As such, a need in the industry exists to create a system that is capable of using multiple sets of criteria simultaneously that is compatible with both the lending institutions and the insurance industry. Further, a need exists for a system that allows for the simultaneous review of criteria for a wide variety of loan programs, and different types of loans, for multiple lenders, wherein the preliminary assessment of eligibility for a given program is provided such that the consumer can assess whether providing a loan application to a particular lender is favorable. A further need exists for a system that allows multiple lenders and intermediaries to establish filters or criteria such as terms, conditions and stipulations, that set forth the conditions of each program and the desired risk for a given transaction, and which allows for real time editing, deleting or addition of these terms, filters and programs. A still further need exists for a system that allows the consolidation of reports or information to the consumer such that duplicative information is not received by the consumer or unnecessarily forwarded by the lender or multiple lenders.

### BRIEF DESCRIPTION OF THE DRAWINGS

The detailed description of embodiments of the invention will be made with reference to the accompanying drawings, wherein like numerals designate corresponding parts in the figures.

FIG. 1 is a network system environment in accordance with a preferred embodiment of the instant invention.

FIG. 2 is a block diagram of the pre-transaction activities of the system and the potential parties to transactions in accordance with a preferred embodiment of the invention.

FIG. 3 is a block diagram of a transaction between a dealer and a lender to purchase a vehicle in accordance with a preferred embodiment of the invention.

FIG. 4 is a block diagram of the development of criteria and filters for a first client in accordance with a preferred embodiment of the invention.

FIG. 5 is an illustrative web page depicting a menu and input boxes for creating a loan program in accordance with the preferred embodiment of FIG. 3.

FIG. 6 is an illustrative web page depicting a menu and input boxes for creating a criteria set for a loan page in accordance with the preferred embodiment of FIG. 3.

FIG. 7 is an illustrative example of a preset loan program, including tiering qualifications sets in accordance with the preferred embodiment of FIG. 3.

FIG. 8 is an illustrative web page of a point value system that determines rate adjustments in accordance with a preferred embodiment of the invention.

FIG. 9 is an illustrative web page of the class manager interface in accordance with a preferred embodiment of the invention.

FIG. 10 is a dealer enrollment application in accordance with a preferred embodiment of the invention.

FIG. 11 is a block diagram of the development of criteria and filters for a second client in accordance with a preferred embodiment of the invention.

FIG. 12 is a block diagram of transaction management tasks of the second client in accordance with a preferred embodiment of the invention.

FIG. 13 is web page of the display of financing results generated by the risk assessment system in accordance with a preferred embodiment of the invention.

FIG. 14 is web page of the display of financing results generated by the risk assessment system, including pop up windows displaying specific program information in accordance with a preferred embodiment of FIG. 13.

FIG. 15 is an insurance application, wherein the dealer inputs supplemental application information in accordance with a preferred embodiment of the invention.

FIG. 16 is a status menu of submitted applications for a dealer in accordance with a preferred embodiment of the invention.

### SUMMARY OF THE DISCLOSURE

Embodiments of the present invention allow multiple participants of the risk assessment and control system, such as multiple lenders and intermediaries, to establish multiple criteria and guidelines simultaneously for conducting transactions, wherein the criteria and guidelines allow for the controlling and assessment of risk in future transactions, namely, the parties can independently preset qualifications and eligibility requirements for participation in specific types of transactions. The risk control system operates on a network, and allows real-time management and development of this criteria via a user interface on a network.

In preferred embodiments, prior to the commencement of the use of the system, the system defines a predetermined type of transaction and creates a template, wherein variables or factors relevant to the type of transaction are defined by the system. Parties desiring to participate in transactions via the system, each independently join the system and independently set up their participant information files and further, establish their particular criteria or filters for participation in the system. Once each participant has established its criteria for transactions, the parties can seek to conduct transactions via the system.

A feature of preferred embodiments of the invention is that each party to a potential transaction can choose parties with whom to conduct business. An advantage to this feature is that each party is only subject to transacting business with parties of its choosing, thereby reducing unfavorable business relations.

A still further feature of preferred embodiments of the instant invention is that lenders in a secured environment, without the assistance of a programmer, can add, edit and change criteria for qualifications of loan programs in real time. An advantage to this feature is that intermediaries, such as dealers, have accurate information and can more quickly assess the loan program suitable for the particular consumer. A further advantage is that the lenders through an interface can immediately, or through time control features, remove or add a program without the need to notify intermediaries.

A further feature of preferred embodiments of the invention is that lenders can offer multiple programs, wherein each program can have unique characteristics, or scoring criteria, to qualify for the program. An advantage to this feature is that the intermediary or, in some instances, the user, has a variety of programs from which to choose for each lender such that some unfavorable financial information will not necessarily prove detrimental to the consumer for the obtaining of a loan.

Another feature of preferred embodiments of the invention is that criteria that is to be applied to all programs can be entered and globally applied in real time. An advantage to this feature is that global changes to the programs can be applied without the requirement for editing every program.

Another feature of preferred embodiments of the invention is that programs can be restricted by a variety of factors, including, but not limited to, locations, parties, groups, and time frames. An advantage to this feature is that a program can be developed for an extremely specific situation and limited in scope of access.

A still further feature of preferred embodiments is that only one conditionally approved loan can be made for each applicant. An advantage to this feature is that the acceptance rates of loans by applicants increase, thereby reducing costs of processing needless applications by the lender.

A further feature of preferred embodiments of the invention is that upon receipt of the consumer's credit information, the intermediary can search for the program most suitable for the applicant based upon the applicant's credit profile via the risk analysis system. An advantage to this feature is that the intermediary need only review one location for available programs of preselected lenders and thereby, decreases the amount of time required to qualify the applicant in a program compatible with the applicant's financial criteria.

Another feature of preferred embodiments of the invention is that listings of possible programs are presented to the intermediary upon the presentation of the consumer's credit information. An advantage to this feature is that the intermediary can alter certain input information, such as, down payment amount, and adjust the input information such that the applicant would qualify for the particular program.

A still further feature of preferred embodiments is that multiple requests for a loan can be made for each applicant if multiple lenders requests additional information from the applicant. The advantage to this feature is that lenders may review applicant information selectively, and the intermediary may choose any or all lenders and directly interface with the multiple lenders requesting additional information.

A still further feature of preferred embodiments is that once the intermediary or applicant accepts a loan from a lender which originally requested additional information, the other lenders request for additional information is withdrawn from the system. The advantage to this feature is that, if an intermediary or applicant selects a loan program which requested additional information, the other lenders may stop their review before they incur additional costs.

Another feature of preferred embodiments is that a single declination communication is forwarded to a consumer by the system or intermediary if no lenders will offer a loan to a consumer. An advantage to this feature is that multiple communications are not received by the consumer. A further advantage is that unnecessary declination communications are not forwarded as the system or intermediary are aware of whether at least one loan is offered by a lender and accepted by the consumer.

Another feature of preferred embodiments is that the system accepts notification from an intermediary, such as a dealer, of a loan offer from a lender outside of the system and acceptance by the consumer. An advantage to this feature is that unnecessary declination communications are not forwarded to the consumer.

The above and other advantages of embodiments of this invention will be apparent from the following more detailed description when taken in conjunction with the accompanying drawings. It is intended that the above advantages can be achieved separately by different aspects of the invention and that additional advantages of this invention will involve various combinations of the above independent advantages such that synergistic benefits may be obtained from combined techniques.

### DETAILED DESCRIPTION OF PREFERRED EMBODIMENTS

Preferred embodiments of the instant invention operate on a network, such as, for example, the Internet or World Wide Web (“WWW”), or any other type of network system, including, an internet or an intranet.

Hardware Environment:

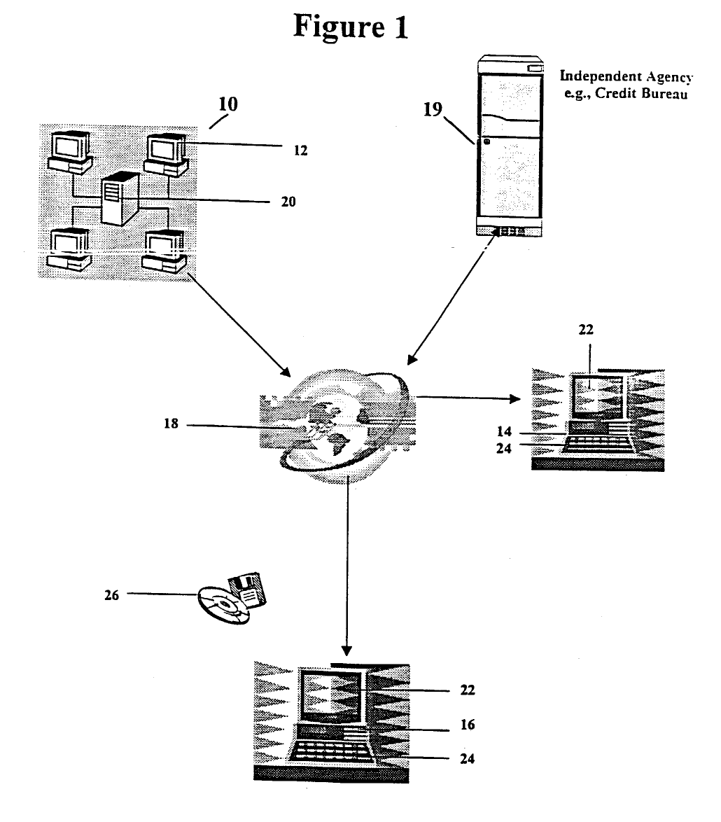

Preferred embodiments of the instant invention operate in accordance with a plurality of networked computers, such as, for example, a user computer and a server computer which are coupled together on a communications network, such as, for example, the Internet or a wide area network. FIG. 1 depicts a network system 10 that operates in accordance with preferred embodiments of the invention. In preferred embodiments, the network system 10 includes a server computer 12, or a provider computer, a first client, or first user computer 14, a second client, or second user computer 16, wherein the provider computer 12, the first client computer 14 and the second client computer 16 are in electronic communication with each other via a communication link 18.

In some preferred embodiments, the network system 10 includes a plurality of either the server 12, the client computers 14,16 or any combination thereof. The provider computer 12 contains information for assessing and controlling risk in predefined types of transactions, and other relevant data that is accessible by the user computers 14, 16, or clients. The network 10 can include one or more provider computers 12 that are operatively connected to the communication link 18, wherein each of the provider computers 12 can contain information for assessing and controlling risk for types of transactions that differ on each provider computer 12. It will be understood that network systems in accordance with further embodiments may include more than two provider computers 12.

The provider computer 12, or server, may comprise any suitable network device capable of providing content (data representing text, hypertext, photographs, graphics video and/or audio) for communication over the network. In preferred embodiments, the provider computer 12 comprises a programmable processor capable of operating in accordance with programs stored on one or more computer readable media (for example, but not limited to, floppy disks, hard disks, random access memory RAM, CD-ROM), to provide content for communication to client computers 14, 16. The provider computer 12 may comprise, for example, but not limited to, a personal computer, a mainframe computer, network computer, portable computer, personal digital assistant (such as, a 3Com Palm Pilot), or the like. The provider computer 12 may include one or more internal data storage devices (not shown) for storing content for communication to a user computer 14. Alternatively, or in addition, the provider computer 12 may be coupled to an external data storage device, computer or other means, generally represented at 20, from which the provider computer 12 may obtain content for communication to client computers 14, 16. In one embodiment, the external device 20 may comprise a further network device coupled in the network 18. The provider computer 12 is controlled by suitable software to provide the requested content to the requesting client computers 14, 16, provided that various criteria are met.

In a preferred wide area network environment, such as the Internet environment, the provider computer 12 is controlled by suitable software to respond to a valid request for content by providing (or downloading) data in the form of, for example, one or more HTML files to the user computer 14 from which the request was made. It will be understood by those skilled in the art that this process involves communications through suitable servers, routers and other components, as is dictated by the particular network environment.

Each server 12 operates with a persistent storage means (not shown), for example, one or more of the fixed and/or removable data storage devices and/or data communications devices connected to the computer. The communication link 18 may include a public network, such as the Internet, a local area network, or any other suitable communications connection, hardwired, wireless, or a hybrid thereof.

The client computers 14, 16 may comprise any suitable network device capable of communicating with other network devices in the network system. In preferred embodiments, each client computer comprises a programmable processor capable of operating in accordance with programs stored on one or more computer readable media (for example, but not limited to floppy disc, hard disc, computer network, random access memory (RAM), CD Rom, or the like), a display device 22 for providing a user-perceivable display (for example, but not limited to visual displays, such as cathode ray tube CRT displays, light-emitting-diode LED or liquid-crystal-diode LCD displays, plasma displays or the like, audio displays or tactile displays), and a user input device 24 (for example, but not limited to, a keyboard, mouse, microphone, or the like). In one preferred embodiment, at least one client computer comprises a personal computer system having a CRT display, a keyboard and a mouse user-input device.

The client computers 14, 16 are controlled by suitable software, including network communication and browser software to allow a user to request, receive and display information (or content) from or through a provider computer 12 on the network system 10. The client computers 14, 16 operate in accordance with programs stored on a readable medium 26, including, but not limited to, floppy disks, hard disks, RAM and CD-ROM. The client computers 14, 16 are any means capable of communicating with the provider computer 12, including, but not limited, to personal computers, kiosks and ATM-type machines. The client computers 14, 16 access the server computers 12 via the wide area network or through some other remote access, such as, for example, by telephone, facsimile, personal digital assistant, pulse code system, web TV, or any other device or method that communicates alpha numeric data with a server.

General Description of Preferred Embodiments

Embodiments of the present invention are directed to a method, apparatus and system for controlling and assessing risk in transactions. In particular, embodiments of the present invention allow multiple participants of the risk assessment and control system to establish criteria for participation in a transaction, namely, the parties can preset qualifications and eligibility requirements for participation in specific types of transactions. The risk assessment and control system further allows real-time management and development of this criteria via a user interface on a network.

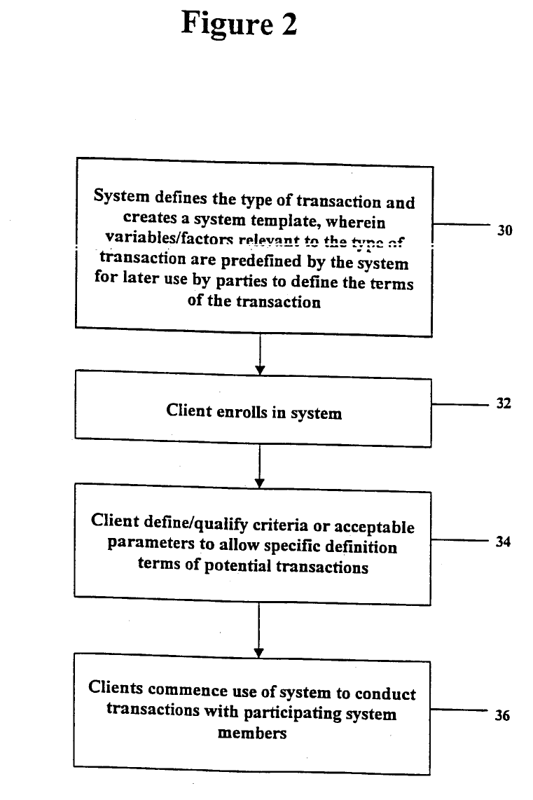

With reference to FIG. 2, overall, in preferred embodiments of the instant invention, prior to the commencement of the use of the system, the system defines a predetermined type of transaction and creates a template 30, wherein variables or factors relevant to the type of transaction are defined by the system. The variables are later used by parties to a given specific transaction to define the terms of that transaction. The variables characterizing the transaction are determined by any suitable means, including, but not limited to, research or discussions with professionals in the industry. For instance, if the anticipated transaction were a loan for a house mortgage, variables such as amount of loan range, interest rate, fees for loan and the like, would be preset in a template for later access by parties desiring to engage in this type of transaction. In some preferred embodiments, a party can provide the system with additional, or specialized variables, or an entirely new list of variables for a template specific to that party.

Parties to a potential transaction enroll or become a member or a participant of the risk assessment and control system 32. The risk control system operates on a network, wherein member participants of the system each can independently access the system and set up participant information files and further, establish the criteria or filters for their participation in transactions 34. Once each participant has established its criteria for transactions, the parties can seek to conduct transactions via the system 36.

In preferred embodiments of the invention, parties to a transaction are represented by a first client 14 and a second client 16, wherein the first client 14 represents the party offering the goods or services and the second client 16 represents an intermediary or agent for a third party desirous of participating in the transaction. It is to be understood that the second client 16 could represent itself in the transaction as well, and thus, it becomes the party desirous of participating in the transaction.

A first client 14 accesses the system and lists available goods and services that are being offered by the first client 14, including the terms and conditions of acquiring these goods and services. For example, if the first client 14 is a lending institution, the first client 14 would identify available loan programs offered by its institution and identify the terms and conditions of participation in each program, including, but not limited to, parties with whom they will conduct business, security filters, fees, terms and conditions of each program and eligibility requirements for participation in each program. Similar to the first client 14, the second client 16 also accesses the system and establishes conditions under which it will participate in a transaction, including, but not limited to, identifying security filters and parties with whom they will conduct business.

The system allows real time, instantaneous modification of terms and conditions, including wholesale deletion of an offering, or the removal or addition of the parties acceptable for a transaction. As each party operates independently of all other parties, modifications can be made without prior notice or regard for the other member participants and can be solely due to changing circumstances or changes in preferences of the participating party. The ability to instantaneously modify the criteria for participation in a transaction ensures other parties that the criteria represents active and accurate offerings.

Although the system can be utilized in any type of transaction, for purposes of illustration, the following description will be directed to transactions between lending institutions and an intermediary, such as a car dealer, wherein the intermediary represents a third party, such as a consumer. It is to be understood that the following description is illustrative of embodiments of the invention and is not intended to be limiting.

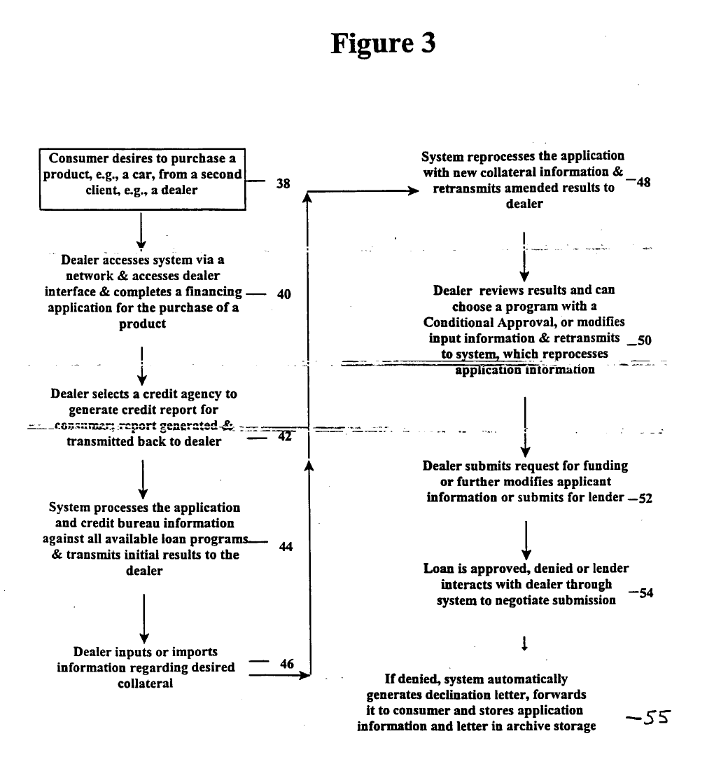

With reference to FIGS. 1 and 3, in one preferred embodiment a consumer desirous of purchasing a car contacts the second client, that is, a car dealer 38. The car dealer accesses a dealer interface page transmitted from the provider computer 12 and completes an application for the consumer 40, wherein the application includes, but is not limited to, a request for financial information, employment information and residence information. In addition to completing an application, the dealer requests a credit report, and via a pull down menu on the interface page, chooses a credit bureau to generate the report. Upon selection of the credit bureau by the dealer 16, the system 10 transmits a request to the credit bureau 19 (see FIG. 1), which generates a credit report for the applicant and transmits the credit report to the dealer 42. The application information, including the results of the credit report, is stored in a database. Upon completion of the application information, a request for financial analysis can be made by the dealer. Once the request for financial analysis is transmitted, the system processes the applicant information and credit bureau information against all possible loan programs available for each lender that currently participates in transactions with the dealer 44. The dealer receives the initial results of the analysis as available financing options for the applicant. The loan program options for which the applicant qualified are listed as “Conditional Approval,” “Submit For Approval” and “Declined.” A “Conditional Approval” means that the information submitted meets all of the lenders criteria, while a “Submit for Approval” means that the information does not meet all of the lenders criteria, but the deviations are such that the lender would still like to review the application for possible approval. Finally, “Declined” means the lender is not interested in reviewing the application. Initial qualification is based solely on applicant information, such as, debt and income, and excludes information pertaining to the desired collateral. A primary benefit at this point is the lenders on the system have qualified the applicants credit risk separately from any terms of the pending transaction. An initial processing of the applicant information is beneficial to the dealer in that it assists in matching a vehicle to the customer based on financial availability and qualified financing options. It is to be understood that the dealer can input the applicant information, collateral information, and request bureau information simultaneously, and thus, the initial analysis by the system reflects results based on all factors relevant to the decision.

Once the dealer has received the initial results of the analysis for the applicant, the dealer inputs or imports from a dealer inventory control system the information regarding the desired collateral 46, that is, information regarding, for example, the car to be purchased, such as, type, model, mileage, price, and age. The system reprocesses the information which now includes the collateral information and transmits the new results to the dealer 48. The new results of the analysis possibly present the dealer with new information on the financing options page in the form of warnings for each loan program previously available to the applicant. In preferred embodiments, a warning can be directed to the collateral itself, or the warning can indicate that the terms or structure of the deal exceed program guidelines and need to be changed. Any deal with a warning causes a Conditional Approval status to be downgraded to Submit For Approval status. In this instance, if the dealer still desires the particular program, the dealer must adjust the terms of the deal to achieve a status reclassification of the program to a Conditional Approval.

Once the dealer has reviewed the new results, the dealer can choose a program having a Conditional Approval status, or can make modifications to the applicant or collateral input information in an effort to meet the eligibility criteria of a given program 50. The dealer can now submit a request for funding for a program having a Conditional Approval status, or can further modify applicant and collateral information, or can submit a Submit for Approval for a lender review and direct communication with the lender through the system 52. The loan is now approved or the lender contacts the dealer via the system or by any other suitable means, to negotiate a Submit for Approval submission 54.

Since the terms of the loan have been preset by the lender and the applicant has been prescreened by the system against the preset terms, if the dealer chooses a program having a conditional status, the likelihood of loan approval is favorable to the consumer. Prior to the submission of the loan application to the lender, the dealer has exclusively preprocessed the application without contacting the lender for any information. In this manner, the lender has not yet incurred any costs or expenditures of time in reviewing the loan application, and the application received is, most likely, in favorable condition for approval due to the prescreening in conjunction with the loan restrictions.

The only cost or expenditures of time that is required by the lender is for Submit For Approvals. The lender is provided a complete set of information from which to either Conditionally Approve the deal, or Decline. During this evaluation phase the lender is provided the means to use an instant messaging system to discuss and negotiate the deal to completion. While not as favorable as a Conditional Approval, a Submit for Approval still meets most of the preset criteria established by the lender and has met the lenders preset parameters for accepting deviations for review. Thus, the lenders cost for loan review and approval is still significantly reduced.

If a lender, or multiple lenders decline to offer a consumer a loan, or the consumer will not agree to the preset terms of at least one loan, the system automatically generates a declination communication, that is, a declination letter, and forwards it to the consumer 55. The declination letter sets forth the reasons for decline by each lender, namely, the criteria unacceptable to the lender. Once the letter has been forwarded to the consumer, the letter and application information is stored in the system database 55. In preferred embodiments, the declination letter is generated within a predefined time period.

As stated above, the declination letter which is forwarded to the consumer includes a listing of each lender and the specific reasons for declination set forth by each lender. In addition to the specific reasons, the letter can include other legal requirements, including, for example, the advisement of the consumer's right to obtain a free copy of the credit report. In some preferred embodiments, the letter is generated at the request of the dealer upon the termination of the loan application without a successful completion of a loan. In some preferred embodiments, the dealer requests the generation of the letter by clicking on a predefined button on an interface page. In still other embodiments, the dealer can generate the letter manually by compiling the rejection information for each letter.

In instances wherein the consumer could not obtain financing from a lender within the system, but has received and accepted at least one offer of financing from a lender outside of the system, the system is configured to receive notification of the acceptance and offer of financing for the consumer. In this regard, if the system is configured to automatically transmit a declination communication, the dealer could suspend the system's automatic generation of the letter by transmitting notification that the consumer has received and accepted an offer of financing from a lender outside the system. The notification to the system will suspend the automatic generation and forwarding of a declination communication to the consumer. If the system is configured such that the dealer requests a declination communication from the system, the dealer would simply not request the declination communication, but rather would transmit notification to the system of the financing offer and acceptance such that the system could properly note the successful completion of the transaction.

If the letter is generated by the system, the system can transmit the letter to the consumer, or can transmit the letter to the dealer for distribution directly to the consumer via mail or hand delivery if the consumer is still present at the dealer's office. Once the declination letter is forwarded, it is stored in the system and made available to the lender upon request. In some preferred embodiments, a message is transmitted to each declining lender for their records and review. In some preferred embodiments, the third party generation and distribution of the declination letter can be declined by the lender such that this requirement is controlled and managed by the lender. In these instances, the lender opts out of being included in any declination letters generated by the system. One lender opting out will not affect any other lender, and thus, a declination letter could be generated with less than the number of declining lenders involved in the attempted transaction.

As discussed above, prior to any transaction occurring, the lender and the dealer preset the terms and conditions of their participation in transactions. In one preferred embodiment, the lender and dealer input information into the system via a series of web pages, wherein the series of pages guide the lender or dealer as to the data required to set up their participation profile and parameters or criteria in the system.

The requirements for each party to a potential transaction differs, as each party performs a different role in the transaction. As such, each client, that is, the first client 14 and second client 16, will be separately discussed, although some features of participation are similar.

In one preferred embodiment, access to the risk assessment system is accomplished via a series of web pages that provide an interface for the clients 14, 16. With respect to the lender, the lender interface allows lenders to manage criteria sets, terms and conditions, stipulations and subjective underwriting rules. In this manner, parties desiring to transact business with the lender, for example, the second clients, can obtain current financing options and have confidence in responses received from the lenders, wherein the response is typically received via the network.

In preferred embodiments of the invention, prior to participation in the system or any participation in transactions via the system, the first client 14, for example, a lender, is enrolled onto the system. Enrollment in the system allows lenders to appoint a system administrator, distribute its programs in selected geographical territories, and establish contact information. In preferred embodiments, the lender enrollment information is completed by the system via an enrollment page, wherein a system representative completes preset information boxes. Information requested includes, but is not limited to, lender name, tax identification number, address, time zone, telephone number, facsimile number, administrator's name, administrator's email address, contact's name, contact's email address and authorized states in which the lender can legally transact business. In addition to the above information, the lender can indicate preferences with respect to services or features offered by the system. For instance, during enrollment, the lender will be allowed to opt out of the automatic generation of the declination report to the consumer. If the lender decides to opt out of this feature, in one preferred embodiment, the lender checks a box on the enrollment interface page indicating the choice to opt out of this feature. If the lender does not indicate a desire to opt out of participation in this feature, the system defaults and includes the lender in this feature. In another preferred embodiment, the lender can access an enrollment page, complete the enrollment information, including indicating preferences regarding system services and features, and submit it to the system. For example, in some preferred embodiments, the lender can specify the language to use for specific declination reasons with respect to that lender. If the lender does not specify any particular language, the system defaults and utilizes predefined language. It is to be understood that the lender can request, or amend a request, for specific declination language, or can revert to predefined language, at any time.

Upon completion of the enrollment page, the information is transmitted into the risk assessment and control system. The input information is stored in a database and a membership profile is established within the system for the lender. The membership profile is simply an identification file for the lender and does not include any offerings available through the lender. Once the profile information is established for the lender, a unique user name and password is developed by the lender. In one preferred embodiment, the lender's information is manually reviewed by a system representative. However, in other preferred embodiments, the lender information can be electronically reviewed and compared to criteria set by the system.

Once the lender has obtained a user name and password, the lender logs into the system and accesses the lender interface. As the lender controls its participation in the system, the lender can access the system at any time. Further, the lender is now able to establish its loan programs in a secure environment.

Once the lender has accessed the lender interface, the lender commences the development of its programs, namely, the lender commences the development of its transaction participation criteria and filters. The development of participating criteria and filter 56 comprises creating security filters 58, defining program management criteria 60, and defining dealer management criteria 62.

To control and manage the access to the system and limit the participation in transactions with intermediaries, the lender, via the system administrator, establishes security filters, wherein the establishment of the security filters comprises the establishment of a list of users and passwords for each user 64, and the establishment of a set of privileges or system rights for each user 66. Typically, more than one employee processes loans for a given lending institution. As such, it is desirable to restrict access to the system, or rights within the system for each identified employee.

The establishment of the security filters can be accomplished via a web page, wherein the system administrator inputs the user's name, a password for the user and lists system rights for the user. In one preferred embodiment, a list of system rights is presented to the system administrator as a list of security rights, wherein the system administrator places a check next to each right granted. In other preferred embodiments, the list is presented via a pull down menu. If a right is not checked, the user is not granted those rights. In other preferred embodiments, the user is granted all rights by default and the system administrator must delete rights not intended to be granted to the particular user. Although described with reference to a web page, it is to be understood that any suitable manner of identifying a user in conjunction with a password and a listing of system rights is suitable, including, but not limited to, downloading a text file from the lender that lists the employee's names.

The defining of the program management criteria 60 is the identification, within the system, of the loan programs offered by the lender. Defining of program management criteria comprises defining at least one program 68, defining eligibility requirements 70, defining program terms 72, defining stipulations or special requirements 74, defining classes for programs and dealers 76, and defining the start date of the program, and if the duration of the program is limited, the end date 78. To participate in the system, the lender must establish at least one program within a class, and associate at least one dealer to the class.

To define a program, the criteria or factors characterizing the program must be specifically defined. As discussed above, the factors identifying or defining programs, including factors that establish the terms and conditions of the programs are industry specific, or in some instances, client specific. The factors presented to the lender to establish its loan programs are preset by the system, wherein the compilation of these factors is accomplished by any suitable means, including, but not limited to, independent research or discussions with industry professionals. For instance, with respect to financial transactions, relevant factors include, for example, minimum and maximum loan amounts, rates, points or fees on the loan and the like.

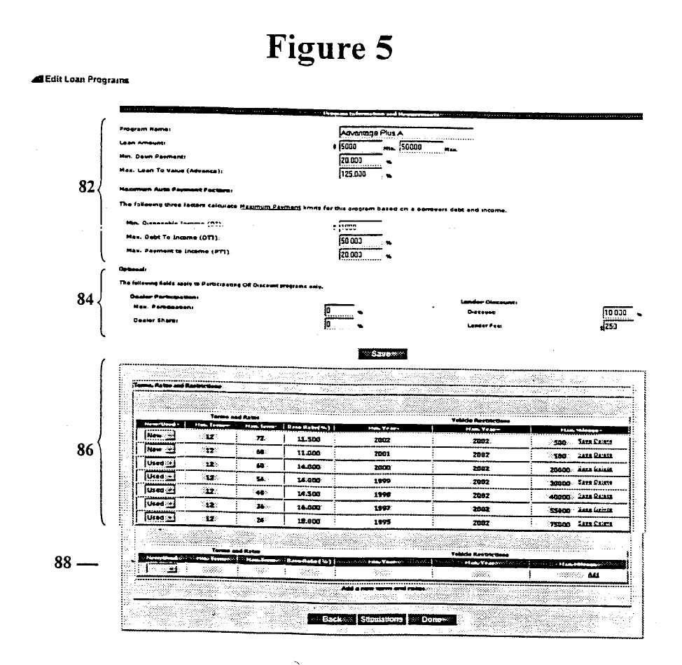

With reference to FIG. 5, in one preferred embodiment, to create a loan program, the lender, or its system administrator, accesses a loan program web page having a series of input boxes 82, wherein the input boxes represent identifying factors by which to define the loan program. In one preferred embodiment, the factors include, but are not limited to, the program name, loan amount (minimum-maximum), minimum down payment, maximum loan to value percentage, minimum disposable income, maximum debt to income percentage and maximum payment to income percentage. In addition, the lender can identify programs that allow for dealer participation or offer a lender discount or require a fee 84.

Once the loan parameters have been established for the particular loan, the lender can also establish terms and conditions to qualify for the particular loan 86, wherein the terms and conditions are appurtenant to the collateral desired to be obtained, for example, a car. In this manner, the lender can establish a series of acceptable collateral parameters that will qualify for the identified loan program. For instance, the lender can identify whether the collateral must be new or can be used, the minimum and maximum term of the loan, the rate, the minimum and maximum year of the car, and the maximum allowable mileage. In this manner, even if an applicant qualifies for the loan, the lender can be assured that the loan is secured by acceptable collateral, and thus, the identification of acceptable collateral parameters further qualifies the conditions under which the loan will be approved. New terms and conditions can be added via a series of input boxes 88, as illustrated in FIG. 5. Once the series of terms and conditions have been added for a particular program, the lender can save the newly created program by depressing a “Done” or save button. Once a program has been made active, subsequent changes to the program can only be made by the lender after the original program has been archived by the system.

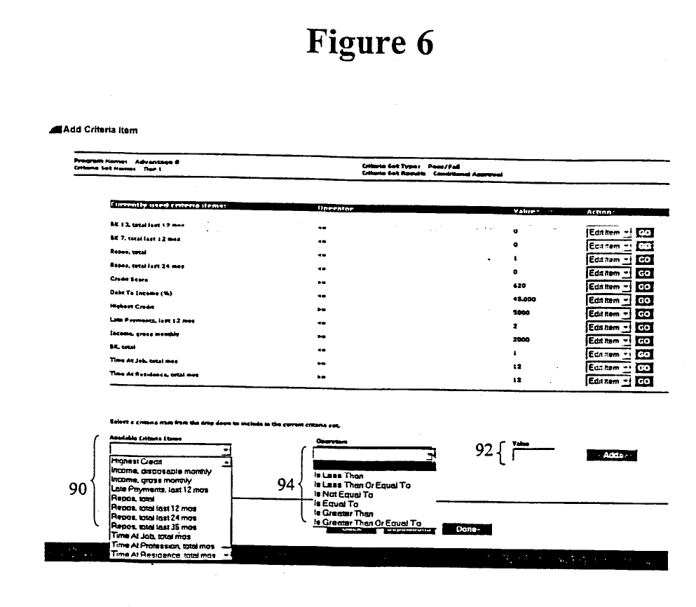

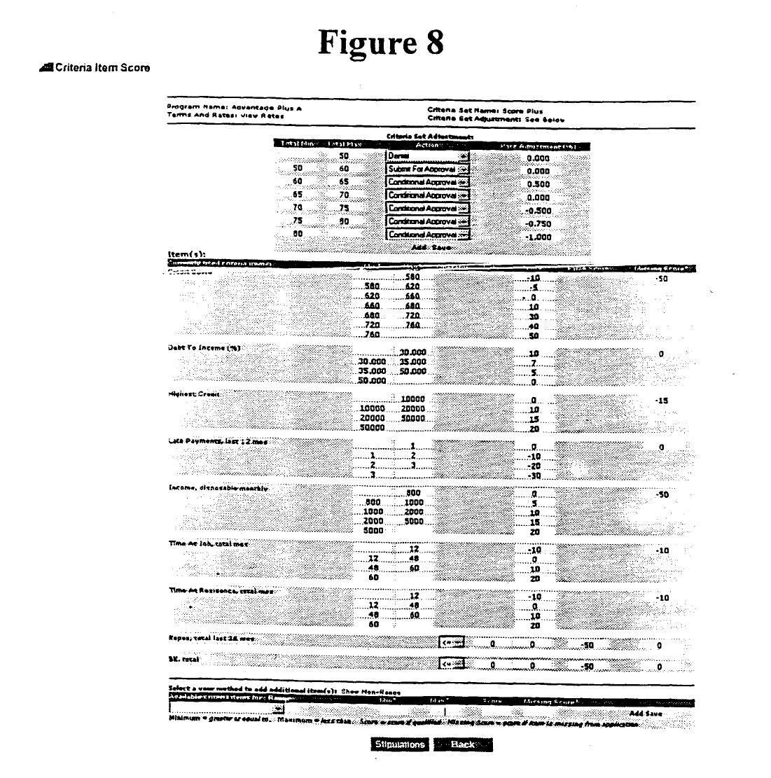

Once the lender has established the specific loan parameters, the lender defines the eligibility requirements. These parameters identify acceptable qualifications that pertain to the applicant and define criteria by which the consumer or third party will be approved for the loan. Although any set of eligibility requirements can be established, in one preferred embodiment, the lenders utilize a set of true/false criteria, a point value system, or a combination of both true/false and a point value system, as illustrated in FIGS. 6 and 8.

The true/false criteria are a set of criteria whereby a particular factor is either true or false for a consumer. For example, the income of a consumer exceeds a preset amount. If this is true, the consumer has passed this factor. Approval status is associated with each factor, for instance, if a consumer passes a particular factor, the consumer may receive a conditional approval or a ‘submit for approval’ status.

With reference to FIG. 6, the system administrator, or lender, accesses a web page listing a predefined set of criteria, which may be designed to the specification of the lender, wherein this set of criteria has been provided by the system as discussed above. In one embodiment, the lender accesses the listing of criteria via a pull down menu 90. In one embodiment, the criteria includes bankruptcies within a predefined period of time (both chapter 7 and 13), total number of repossessions within a predefined period of time, credit score, time at job, time at profession, and time at residence. It is to be understood that any other criteria can be added to system, and in particular, specific requirements of a specific client can be added by the system for the particular client. For each true/false criteria, the system administrator indicates a value for the factor and an operator for that value, namely whether the applicant's information must be greater than or equal to, or less than or equal to, the value. For example, an applicant income must be greater than or equal to $1800. In one embodiment, the lender inputs this data via an input box 92 and a pull down menu 94.

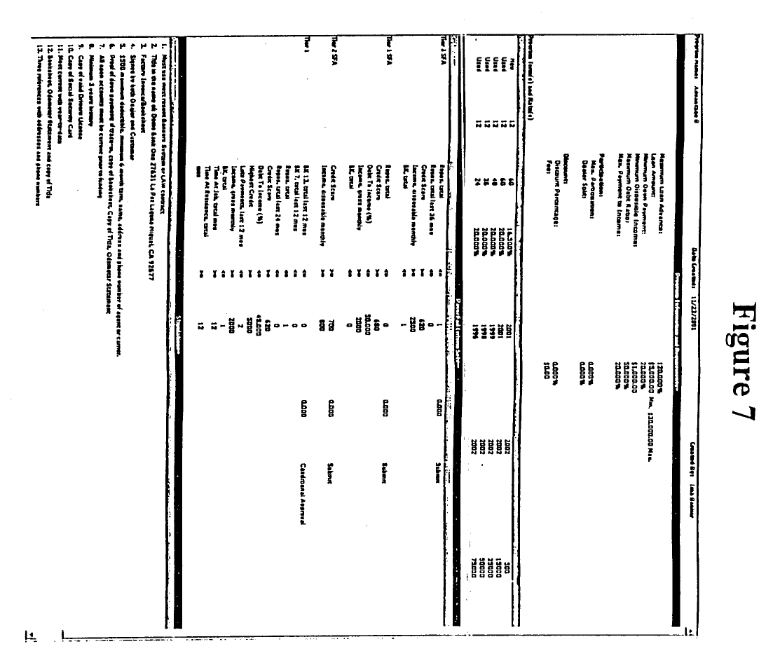

From the true/false set of criteria, the lenders can create tiering qualification sets for each loan, wherein the tiering qualification sets allows groupings of different true/false criteria with varying values. In this manner, greater flexibility is afforded the applicant in being able to qualify for a loan. For example, an applicant with a high income may qualify regardless of whether that individual has recently filed for bankruptcy, whereas if only one set of true/false criteria were available the lender may not even accept submission of the application. The tiering levels are created through the web page discussed above, (see FIG. 6), wherein the tier is associated with the program name and identified by a criteria set name. In this regard, multiple criteria sets can be associated with a particular program using minimal time and effort of the system administrator. FIG. 7 is illustrative of a sample loan program created by a lender and its associated tiering sets, whereas the lender may allow for both objective and subjective underwriting rules.

The point value system, or scoring criteria, allows the lender to add or subtract points from the interest rate. With reference to FIG. 8, to establish a score, the lender establishes ranges of values for a predefined set of factors that are chosen by the lender from the preestablished system set, such as, but not limited to, credit score, debt to income percentage, monthly income and the like. The applicant's information is compared to each range value and scored accordingly. The lender can indicate via the lender interface the scores which will be acceptable to qualify for the loan such that the intermediary is placed on notice of the likely response of a lender prior to submission of a loan application. For instance, if the applicant's score is below a preset number, the lender may indicate that the loan will be denied, however, if within a certain range, the lender may indicate a ‘submit for approval’ or conditional approval with a rate adjustment.

In addition to establishing these values, as with other portions of the risk assessment and control system, the system is advantageous in that it allows the lender the ability to withdraw an active program and add, change, or edit either set of criteria in real time, and then reactivate a new program, and thereby, immediately update associated programs and provide the most current and accurate information. Thus, if a lender must tighten or loosen its lending standards, the lender can efficiently amend this data without direct notification to participating dealers and without risking that dealers are accessing old information that will cause the application to be rejected. Further, if desired, these factors can be changed specifically for one program without affecting the other established programs in general.

The creation and use of multiple sets of criteria illustrates the flexibility of the system in accommodating various types of transaction considerations. Indeed, in this embodiment, the use of multiple sets of criteria allows the lender a wider range of options on qualifying a loan. Further, the use of multiple types of criteria allows the lender to qualify the consumer based on criteria important to other parties, such as, insurance carriers, which inherently review factors different from the factors reviewed by the lending institutions. Indeed, in one preferred embodiment a supplemental application is presented which allows the applicant to complete additional underwriting questions for insurance and other criteria based products that complete information was not included within the loan application. The use of existing data helps eliminate data input errors and alleviates the need to have multiple inputs of the same data, thereby saving time and cost.

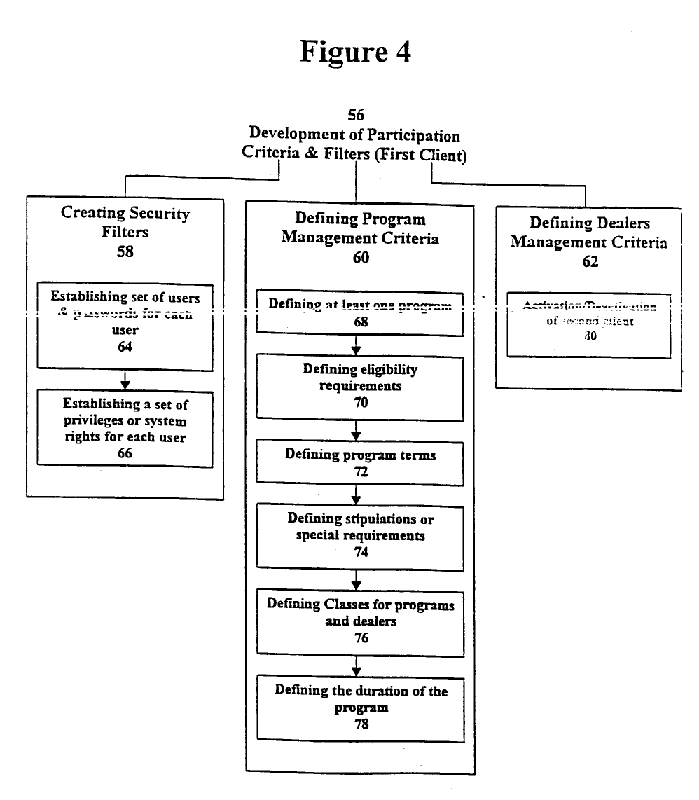

With reference again to FIG. 4, in addition to defining the loan profile and the eligibility requirements, the lender can establish stipulations 74. A stipulation is a type of requirement that usually is action specific and not established by applicant information. For example, proof of a driver's license can be one such stipulation. Stipulations are generally set at the time the loan profile is established via a button at the bottom of the web page (see FIG. 5); however, stipulations can be created by the lender at a time subsequent to the creation of a program and applied at this later time. Further, stipulations can be applied to all programs at the same time, to selected programs or selected criteria items. With reference to FIG. 5, depression of the button at the bottom of the loan profile page transmits the lender to a stipulations page, wherein the lender can edit, add or delete a stipulation and assign or reassign stipulations to programs. The stipulation page lists the stipulations defaulted for the particular lender and further, allows the lender to create a new stipulation. In some preferred embodiments, if a lender desires to create a new stipulation or change the programs to which particular stipulations apply, a listing of programs can be accessed, wherein the program listing also lists the associated stipulations such that modification of the stipulations can be easily made for each program.

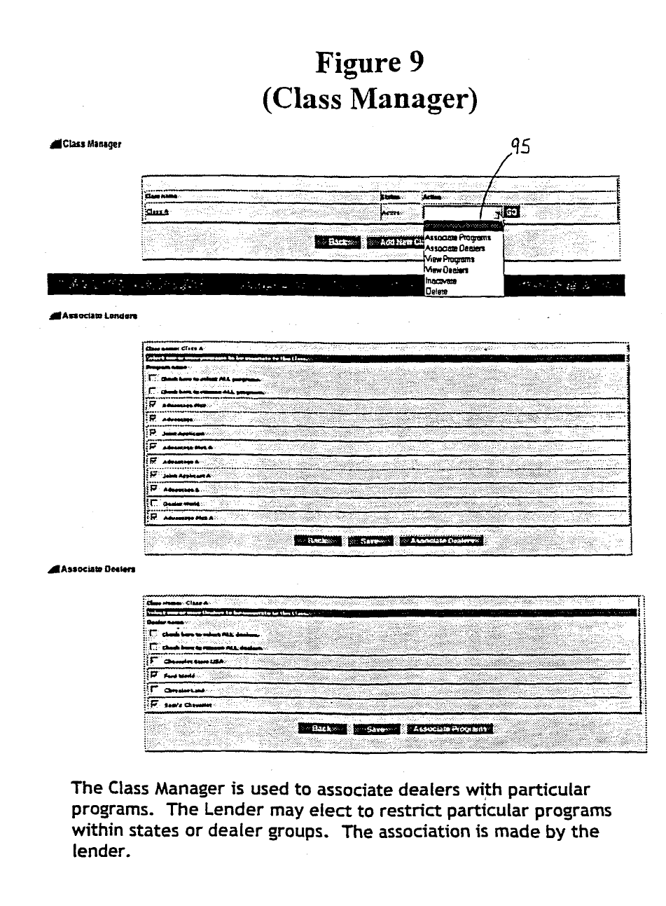

With reference again to FIG. 4, once the program and its limitations have been established, the lender defines classes for programs and dealers associated to the classes 76. With reference to FIG. 9, the lender defines classes via a class manager. Classes define groupings of programs and dealers such that the task of authorizing dealers for programs is minimized. The class creates a linking mechanism between loan programs and dealer (or dealership) organizations associated to the lender. Classes can be created based upon varying criteria, such as for example, geographic locations, number of years in business, or the type of vehicles sold. Once a class is identified, programs can be associated with the class.

A new class can be defined or named by depressing a button ‘add new class’. Once a new class is named, the lender can associate programs and dealers with the class.

To choose programs to include within a class, the lender accesses a list of available programs via a pull down menu 95. The lender selects programs by clicking on a box adjacent the program name. Similarly, the lender selects dealers by accessing a list of available dealers via the pull down menu 95. The lender selects the dealer by clicking on a box adjacent the dealer. The selected program and dealer information can be saved in a database.

Any identified loan program can be assigned to a class even if the loan program is not yet activated. Similarly, any dealer can be assigned to a class even if the dealer is not yet activated by the lender. One or many loan programs and one or many dealers can belong to one or many classes. In this manner, lenders can link a confined set of programs to a confined set of dealers. Thus, for example, if a program is designed only for Texas, a class for Texan dealers could be established, wherein every dealer in Texas becomes part of the group. The program or programs pertaining only to Texas would be associated with that group. In this manner, these programs would only be accessible by the dealers identified in the group and no other dealers would be apprised of the programs.

To commence the program, the lender accesses a launch program page, wherein the lender defines the duration of the program 78 by entering the start and end date for the identified program. Further, an existing program could be immediately started or terminated via this page even if the termination date has not been reached. This allows the lender to establish special programs that exist only for a defined period of time or to start or terminate programs at any time.

The online and network access to the system allows for the establishment of complicated programs in an efficient and inexpensive manner. Indeed, programs can be copied and modified such that a new program is established without duplicating input efforts. Further, and as discussed above, very specific programs can be created for targeted markets and targeted time frames. Thus, the system allows the lender greater flexibility in the offering of programs. Further, the ease of modifications and updating of information allows for instantaneous changes to the marketplace and the reduction of liability for the use of old program information due to the inefficiencies of notification of the marketplace.

In addition to identifying program management criteria, the risk assessment and control system allows the lender the ability to limit its programs to predefined dealers via identifying dealer management criteria 62 (FIG. 4). As will be discussed below, upon enrollment in the system, dealers submit their dealer profile to selected lenders with whom they would like to conduct business. Dealers are notified on their site of available lenders which, for example, conduct business in their state and have a desire to transact business with their particular type of dealership, such as, Franchise or Independent Dealers. Once a lender is selected, the dealer transmits their request to the lender to be activated by the lender. The lender may elect to activate or deactivate a dealer. The requesting dealer is listed on a dealer activation page associated with the lender. If the lender desires to conduct business with the dealer, the lender can activate the dealer via a pull down menu 80. Similarly, a lender can deactivate a dealer via the pull down menu and document the reason for the action via depressing a button, “add note”. In this manner, the lender controls, in part, the parties to its transactions and may document and review historic notes pertaining to parties.

Although the above has been described with respect to a lender establishing itself on the system, any of these processes can be conducted throughout the lender participation period in the system. Indeed, the deletion, modification or addition of programs subsequent to the initial establishment of the programs can occur at any time. Thus, the system creates a dynamic marketplace with current and accurate information that allows for the reduction of transaction time and cost due to the preestablishment of transaction parameters by the parties.

Referring to the second client, or intermediary, similar to the lender interface, the dealer, interface allows the dealer to perform a number of tasks, including, but not limited to, editing their profile, managing lenders and management of applications. Further, the dealer interface can include a news bulletin or message board, whereby global messages can be forwarded to all dealer members.

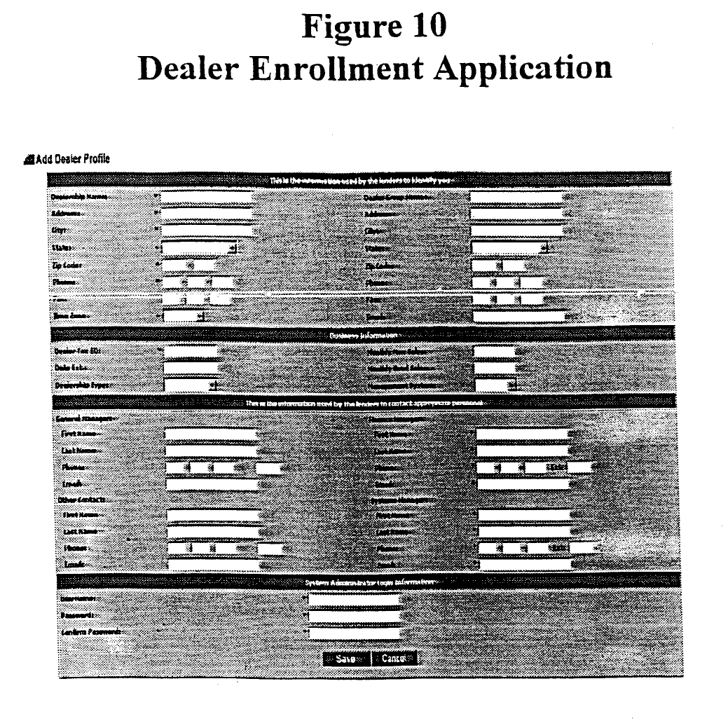

As with the lenders, prior to participation in the system or any participation in transactions via the system, the second client, for example, a dealer, enrolls in the system. Enrollment in the system allows dealers to appoint a system administrator and establish contact information. In preferred embodiments, the dealer enrollment information is completed via an enrollment page (see FIG. 10), namely, a web page, wherein the dealer completes preset information boxes. Information requested includes, but is not limited to, dealer name, tax identification number, address, time zone, telephone number, facsimile number, administrator's name, administrator's email address, contact's name, contact's email address and authorized states in which the dealer can legally transact business.

Upon completion of the enrollment page, the dealer submits the information to the risk assessment and control system. The input information is stored in a database and a membership profile is established within the system for the dealer. The membership profile is simply an identification file for the dealer. Once the profile information is established for the dealer, the dealer selects a user name and password and submits it to the system.

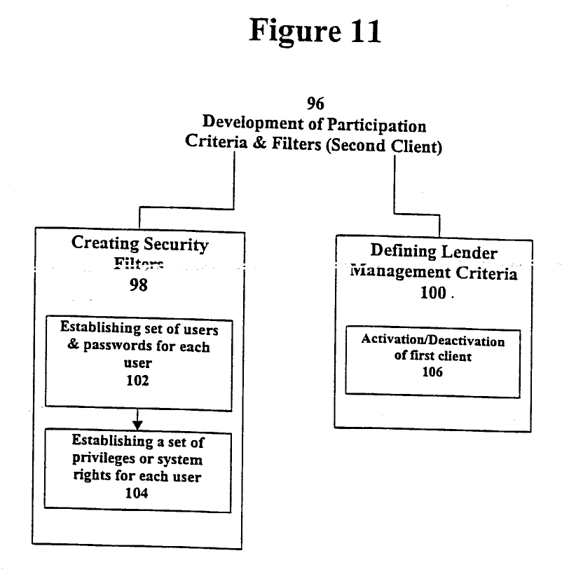

Once the dealer has obtained a user name and password, the dealer logs into the system and accesses the dealer interface. As the dealer controls its participation in the system, the dealer can access the system at any time that is convenient and commence the development of its participation criteria and filters. With reference to FIG. 11, the development of the dealer participation criteria and filters 96 comprises creating security filters 98, and defining lender management criteria 100.

Similar to the lender's need to control and manage the access to, and limit the participation in transactions, the dealers, via their system administrator, establish security filters to control access to the risk system. The establishment of the security filters comprises the establishment of a list of users and passwords for each user 102, and the establishment of a set of privileges or system for each user 104. Typically, more than one dealer employee will be involved in transactions of the sale of collateral, such as cars. As such, it is desirable to restrict access to the system, or rights within the system for each identified employee.

The establishment of the security filters can be accomplished via a web page, wherein the system administrator inputs the user's name, a password for the user and lists system rights for the user. In one preferred embodiment, a list of system rights is presented to the system administrator, wherein the system administrator places a check next to each right granted. In other preferred embodiments, the list of system rights is presented via a pull down menu. If a right is not checked, the user is not granted those rights. In other preferred embodiments, the user is granted all rights by default and the system administrator must delete rights not intended to be granted to the particular user. Although described with reference to a web page, it is to be understood that any suitable manner of identifying a user in conjunction with a password and a listing of system rights is suitable, including, but not limited to, downloading a text file from the lender that lists the employee's names.

In addition to creating security filters, the risk assessment and control system allows the dealer the ability to limit participation in transactions to predefined lenders via identifying lender management criteria 100. As previously discussed, dealers are notified of newly available lenders via their dealer interface information box. A lender overview page will be available to the dealer for review, wherein the overview page will give profile information about the lender. The lender is further listed on a lender activation page associated with the dealer. If the dealer desires to conduct business with the lender, the dealer can activate the lender via a pull down menu 106. Similarly, a dealer can deactivate a lender via the pull down menu 106. In this manner, the dealer also controls, in part, the parties to its transactions.

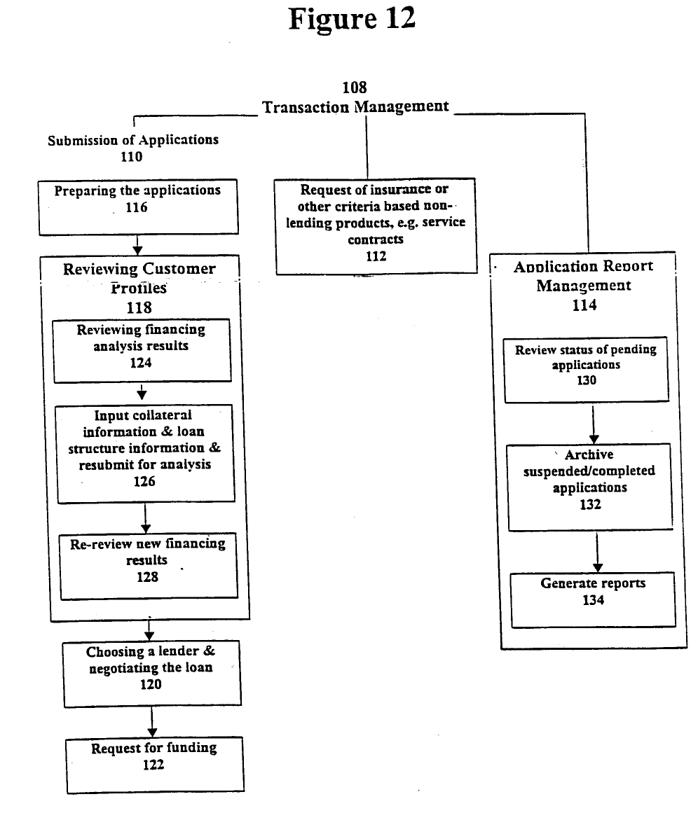

Once the dealer has established its participation criteria and filters, the dealer can begin transaction management tasks. With reference to FIG. 12, transaction management 108 comprises submission of applications from third parties 110, request for insurance or other criteria based non-lending products such as service contracts 112, and management of applications and reports 114.

The submission of applications for transactions, for example, loan applications is generally performed to assist third parties in obtaining financing for the transaction and is separate documentation from the transaction documents, such as, the purchase agreement for the collateral sought to be purchased. The submission of applications comprises preparation of the application 116, review of the consumer profile 118, selection of a lender and negotiation of a loan 120, and request for funding 122.

The preparation of the application is accomplished via a web page accessed from the dealer interface. In preferred embodiments, the dealer completes preset information boxes. Information requested for the application includes, but is not limited to, applicant's name, address, telephone number, social security number, date of birth, years in current residence, status of home (own or rent), income information, and employment information.

Once the dealer has entered the applicant information, the dealer can choose, by checking an input box, the credit bureau that the dealer chooses to generate a credit report for the applicant. The dealer depresses a ‘Get Credit’ button once it has chosen a credit bureau. The system 10 transmits the request to the credit bureau 19 (see FIG. 1). Upon receipt of the credit report, which typically occurs within a few seconds, the dealer can commence review of the consumer profile 118, including review of the credit report. Further, a machine readable file which includes the credit report score is stored in a database for later use by the system during the evaluation of criteria against various loan programs.

After the credit report has been generated, the dealer can request financing information by depressing a ‘Get Financing’ button on the credit application web page. The depression of the ‘Get Financing’ button commences the comparison of the applicant's information against the loan programs that are currently available to the particular dealer. Once the system has completed its comparison, it transmits the financing analysis results to the dealer for its review via a web page.

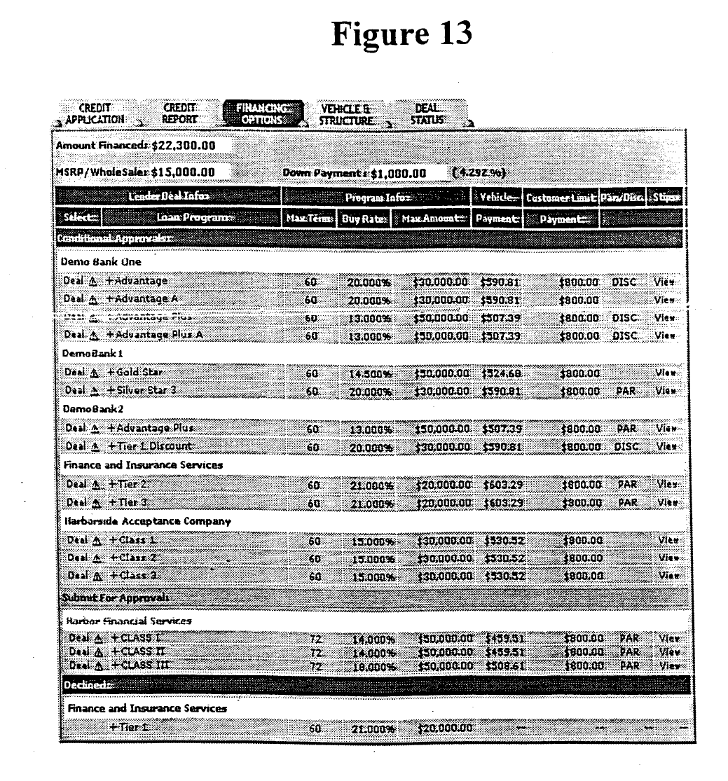

With reference to FIG. 13, the financing results page lists the loan programs, terms of programs and a maximum payment call, that is, the maximum amount of payment the applicant can afford according to the debt ratio requirements of each lender. Based upon the income and debt information of the applicant, the system qualifies the applicant against each program in three status categories; namely, conditional approval, ‘submit for approval’ and declined. The loan programs are listed according to the status assigned by the system. In this manner, a dealer can quickly access what programs are more likely to be approved based upon the applicant's information and the payment amount for which the customer can afford and will qualify.

To view specifics regarding a particular program, the dealer can click on the program name. A pop up window, or any suitable means for providing information, appears on the screen and lists the transaction criteria, including, collateral criteria, for the particular program. Thus, a dealer can quickly ascertain whether the collateral, for example, the car, chosen by the applicant will qualify for the program. Further, the dealer can review whether any participation percentage is available for the dealer if the program is chosen or any finance discount may apply to a particular program.

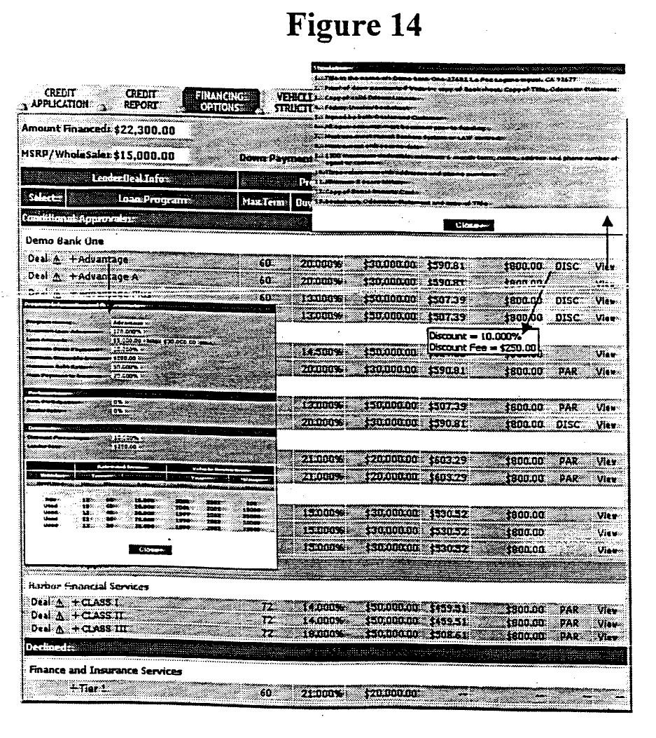

The program listings further includes a pop-up window for discounts, dealer rate participation, and stipulations. (See FIG. 14). In this manner, all aspects of the available programs can be reviewed by the dealer and comparisons can be made between the various programs to ascertain the most favorable program for the applicant.

Once the dealer has reviewed the financing results 124 based solely on the applicant's debt and income information, the dealer selects a vehicle, and inputs, or imports from Inventory Control System, collateral information and loan structure information 126 relating to the chosen vehicle via input boxes on a vehicle input page. The vehicle information required includes, but is not limited to, whether the vehicle is new or used, the year, make, model, mileage, selling price, taxes, fees, down payment and other credit information, the amount to be financed and the percentage down. Upon completion of the input of information, the dealer resubmits the request for financing analysis.

Upon submission of the vehicle information and desired financing information, the system 10 reevaluates the credit application in conjunction with the credit report, vehicle information and desired financing against each of the available programs. A new financing result is transmitted to the dealer for review 128, wherein the new factors are accounted for in the results. The new results include failure factors, that is, items contained in the provided information are not acceptable to the lender. For example, the inputted down payment may not be sufficient, or the vehicle year may not meet the programs guidelines. Further, the new financing results indicate the required monthly payment if the loan is approved and accepted.

At this time, the dealer can change the vehicle, and adjust any of the input values, for example, loan structuring information, such as, down payments. The dealer can then resubmit a request for financing information and receive updated results based upon the new input information. This allows the dealer to adjust the terms of the purchase within acceptable parameters of the consumer, and acceptable parameters of the lenders to facilitate the approval of the most favorable program for the consumer. This type of prescreening minimizes the amount of time and cost that each lender must spend to negotiate the loan, and also minimizes the waiting time for the consumer to receive a loan as the consumer can actively assist the dealer in altering terms and conditions of the purchase without guessing as to the response of the lender. Further, if the consumer assists the dealer in altering the terms and conditions, it is more likely that the terms and conditions of an approved loan are acceptable to the consumer. This alleviates the current situation, wherein the dealers negotiate possible loan terms with the lender and then discuss these potential terms with the consumer. This type of negotiation is time consuming as the real parties of interest are not in communication with each other.

After the dealer and consumer are comfortable and satisfied with their input information and the received financing analysis, the dealer must choose a lender and negotiate the funding of the loan 120. The risk assessment and control system restricts the dealer to the selection of one program displaying a conditional approval or any number of programs displaying ‘submit for approval’ status. In this manner, the efforts of multiple lenders are not wasted in processing a loan, wherein only one loan will be accepted. Thus, the dealer must choose a program and a lender with whom they desire to transact business. Programs displaying a ‘submit for approval’ will receive a system-generated call back from the lenders selected by the dealer.

As discussed above, programs often contained stipulations to conclude the loan. The stipulations can be printed out and maintained in the dealer's files and for the loan package preparation.

Although the dealer has prescreened programs, the lenders still have the final approval of each loan program for a particular applicant. Thus, loan programs having a ‘submit for approval’ status will receive a call-back from the lender. The call-back typically occurs within minutes of submission as the lender may desire manual intervention in their final review of a ‘submit for approval’ request. If a lender chooses to approve the loan, the lender can change the status to conditional approval, or can decline the loan by editing the stipulation page and transmitting it back to the dealer. This allows a prompt review and conclusion of the loan approval process.

The dealers can negotiate with multiple lenders whose programs have returned a ‘submit for approval’ status. In this regard, the dealer can secure multiple conditional approvals thereby increasing the options of loan choices. Further, multiple submissions expedite the receipt of at least one conditional approval of a loan.

In the instance wherein no agreement among the set of lenders and the consumer can be reached regarding the terms of financing, in one preferred embodiment, the system will automatically generate the declination letter and forward it to the consumer. The system will further store the application information and declination letter for later retrieval by the dealer or the lender(s) if required or requested. In other preferred embodiments, dealer will forward a request to the risk assessment and control system for the generation of a declination letter. In these instances, once the system has compiled the necessary information for the letter, the letter is generated and forwarded back to the dealer via facsimile or electronic mail for distribution to the consumer. If the consumer is still in the presence of the dealer, the letter can be directly handed to the consumer and the attempted transaction can be closed. Once the letter is forwarded to the dealer, the system stores the letter for later retrieval by the dealer and lender. In some preferred embodiments, the system automatically forwards a copy of the letter to each lender for their files. In some preferred embodiments, the dealer must request the system to forward the letter to the lenders after the declination letter has been forwarded to the consumer. In some preferred embodiments, the system simultaneously forwards the letter to each of the lenders once the system has forwarded the letter directly to the consumer.

As discussed above, if a consumer could not obtain financing from a lender within the system, but has received and accepted at least one offer of financing from a lender outside of the system, the dealer can transmit notification of the acceptance and offer of financing for the consumer to the system. As such, if the system is configured to automatically transmit a declination communication, automatic generation of the declination communication could be suspended by the dealer transmitting notification that the consumer has received and accepted an offer of financing outside of the system. If the system is configured such that the dealer must request a declination communication from the system, the dealer would only transmit notification to the system of the financing offer and acceptance of financing for the transaction.

To better assist the consumer in receiving financing, during negotiations for programs having a ‘submit for approval’ status, the dealer can amend information and retransmit the amended information to the lender. The interactive nature of the process allows expedited negotiations with multiple lenders to more efficiently secure funding.

Once the lender has conditionally approved a loan, the dealer transmits a request for funding 122. However, the dealer is limited to requesting funding from a single lender that has conditionally approved a loan. Further, if the conditionally approved loan was originally a ‘submit for approval’ status, any other concurrent ‘submit for approval’ status requests by the dealer are automatically suspended or deleted by the system such that the other lenders do not expend needless time and money to process a loan that, most likely, will not be accepted by the applicant. The funding request is transmitted to the selected lender with the credit application, vehicle information, loan structure information, lender's criteria, stipulations and, if desired by the dealer, the credit bureau information. In some preferred embodiments, the dealer can integrate the system 10 into its Dealer Management System (DMS), such as products supplied by ADP, Reynolds or UCS. The DMS allows automatic updating of dealer database information including, without limitation, documentation, inventory, and accounting information.

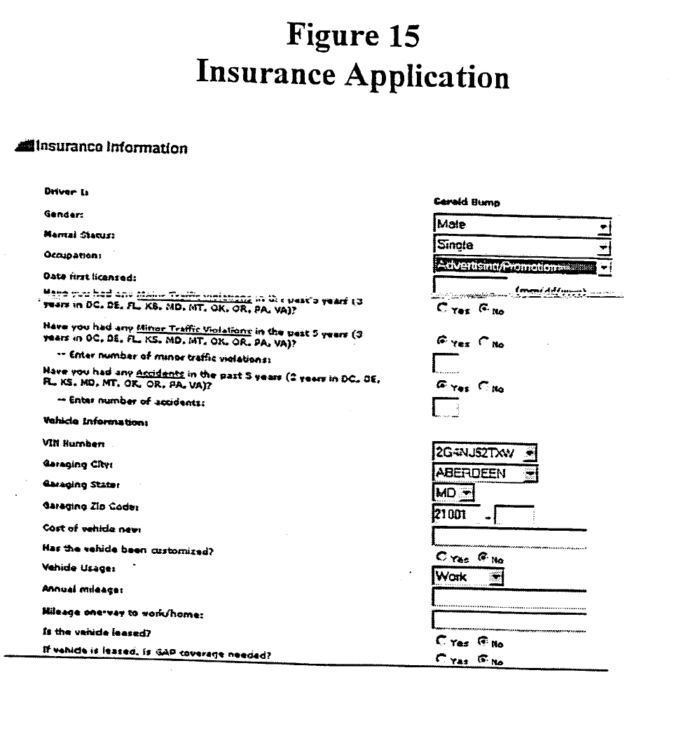

Upon the conditional approval, the dealer can commence the completion of the transaction. In many instances, insurance is required on the collateral prior to the closing of the transaction and removal of the collateral from the possession of the dealer. For instance, prior to removing the car from the dealer's possession the applicant must provide proof of insurance for the vehicle. If the applicant does not have insurance, the dealer, through the system, can request insurance for the applicant 112. The system is configured such that the applicant's credit information, as provided in the credit application, is populated in an insurance underwriting engine. Any supplemental information needed is input by the dealership via an insurance application page (see FIG. 15). The insurance underwriting engine is in electronic communication with the system 10, or in some instances, resides on the same provider computer 12 as the system.

In addition to the information provided from the credit application, supplemental insurance information is required to rate the particular insurance carriers on the system, that is, to obtain quotes from the carriers and determine which carrier is the least expensive. Similar to other input information, the dealer inputs the information via an input box. The requested information includes, but is not limited to, gender of applicant, marital status, date first licensed, traffic violations, accident information, mileage to and from work, garaging city and the cost of the vehicle new.

The system transmits this information to the insurance rating and management engine. The insurance rating engine assesses the information and transmits a quote to the dealer. The dealer or applicant can make the insurance payment via any suitable means, including, a credit card, electronic transfer or by adding the cost to the contract. In some instances, the type of payment is dependent upon the type of insurance selected. Upon payment of the required insurance amount, the dealer can print the applicant an insurance identification card, that is, a proof of insurance.

At the conclusion of the purchase of insurance, the transaction can be completed, including the providing of all stipulation requirements. Once all requirements of the lender have been met, the transaction can be completed and the consumer can receive the vehicle.

The risk assessment and control system is configured to allow the dealer to transact multiple applications at a time and manage applications and reports 114. Application and report management includes status review of pending applications 130, archival of applications 132 and the generation of reports 134.

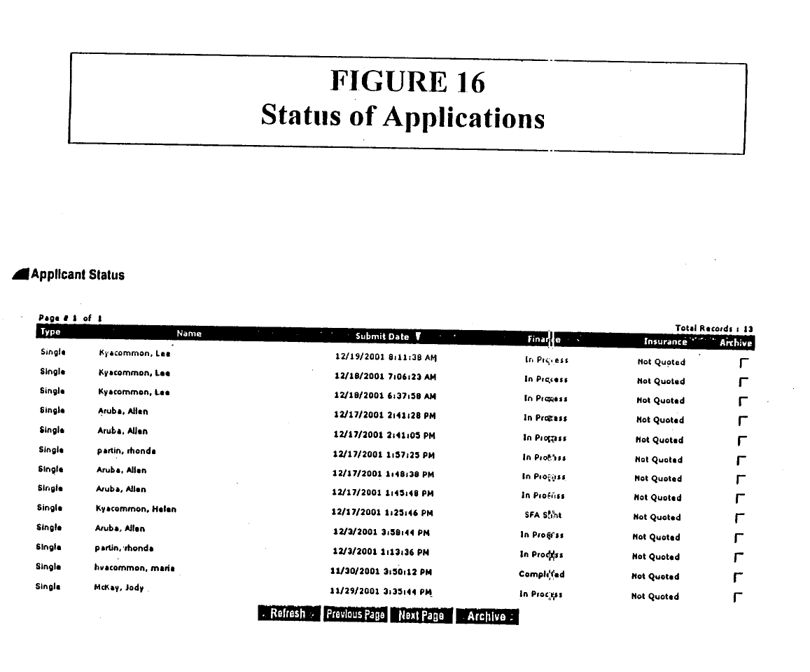

With reference to FIG. 16, the system maintains a listing of submitted applications on a status menu until completion of the transaction. This allows the dealer to review the status of existing applications, follow-up on the applications, including resubmissions and reviews of the applications, and further allows easy management of multiple applications as the system lists the status of financing (for example, in progress or completed), insurance status (quoted or not quoted) and whether the file has been archived 132. Further, the submission date of the application is listed, thereby allowing the monitoring of aging applications. If an application is suspended, for example, due to a consumer's choice to delay the purchase of the vehicle, the application can be placed in an archive. The archive is a database storage that allows easy retrieval of the application. This eliminates the requirement to reenter the applicant's information and allows for amendment of the application if circumstances have changed without the recreation of an entirely new application.

In addition to archiving suspended applications, approved applications can be archived such that the application information can be reviewed for qualification of after market programs. If the applicant could qualify for the after market program, information could be forwarded to the applicant, thereby regenerating business.

To assist the dealer in evaluating the system in conjunction with its business, the system 10 allows for the generation of customized reports 134. For instance, reports can be generated that reflect any type of information relevant to the assessment of the business, including, but not limited to, the percentages of the successful completion of transactions versus pending applications, length of time to finalize a transaction, or percentages of approvals or denials of transactions.

Although the preferred embodiments have been described with a reference to a lender and dealer transaction, as discussed above, the disclosure is not intended to be limiting to these parties or this type of transaction. Indeed, this system can be utilized by any type of transaction. For instance, lenders desirous of selling or purchasing groups of loans can participate in the system, wherein groups of loans (loan portfolios) can be packaged and qualified in accordance with predetermined criteria groupings, for example loan amounts, type and quality of collateral, interest rates, aging requirements, and various selected risk factors. In these instances, if selling loan portfolios, the lenders are second clients, not first clients, wherein the first clients are the purchasers of the loan portfolios. In this case, the lender-to-lender loan portfolio transaction operates in the same manner as an individual loan transaction, however, multiple loans are entered into the system electronically and placed into predetermined criteria groupings. The attributes of these loan portfolios are then transmitted through the system and analyzed against the criteria sets of lenders, that is, first clients, that desire to purchase loan portfolios.

Similarly, the system can be used to create a security based on the payment stream of a group of loans. In these instances, a lender desirous of selling or purchasing a payment stream of a group of loans can participate in the system, wherein groups of loans can be packaged and qualified in accordance with predetermined criteria groupings and the payment stream from such groups of loans can be purchased and sold through the use of the system. Since each criteria model can allow for subsets of additional criteria items that can be used to determine pricing or requirements to cover risk factors that are predetermined by the same, additional or different values within the criteria set, the seller of the payment stream can secure the payment stream, wherein security for the payment stream is, for example, but not limited to, a guarantee, insurance, a credit enhancement or a third party guarantee and the system can take into account the modeled requirements of the purchaser or rating agency (i.e. Moodys or Standard and Poors) due to the financial attributes of the seller and the group of loans. In this instance the Lender selling the payment stream is the second client and the purchaser of the payment stream the first client.

Further, embodiments of the instant invention are not intended to limit the manner in which the transactions are negotiated. It is to be understood that traditional methods of communication, such as, telephone calls, emails, facsimiles and the like can also be utilized to conduct the transaction in conjunction with the system 10, and the system 10 is not intended to exclude these traditional modes of communications. Further, the disclosure it is intended to include other preferred embodiments encompassing modes of inputting, receiving and transmitting information via a network, including, but not limited to, palm pilots, web TVs, intranets, and internets. As such, the foregoing is intended to cover all modifications and alternative constructions falling within the spirit and scope of the invention.

What is claimed is:

1. A system for assessing and controlling risk in a transaction on a computer network having a provider computer, a first client computer and a second client computer, wherein the provider computer, the first client computer and the second client computer are in communication therebetween, and wherein the provider computer predetermines a set of factors for defining a predetermined type of transaction, the system comprising:
means for presenting to the first client the predetermined set of factors, wherein the first client defines factors in the set of factors to create defined selection criteria, wherein the selection criteria represents acceptable parameters of the first client for the transaction;
means for receiving a profile characteristic set from the second client, wherein the profile characteristic set represents data regarding a party desirous of participating in the transaction;
a risk assessment processor, wherein the risk assessment processor is configured to compare the selection criteria to the profile characteristic set and determine whether the profile characteristic set comports with the selection criteria limitations; and
a report generator.

2. A system as recited in claim 1, wherein the report generator is configured to automatically generate a report for transmission to the party desirous of participating in the transaction if the results of the comparison reflects a non-acceptability status of a profile characteristic set for a plurality of sets of selection criteria.

3. A system as recited in claim 1, wherein the report generator generates a report for transmission to the party desirous of participating in the transaction upon the transmission of a request by the second client.

4. A system as recited in claim 3, wherein the second client transmits a request for a if the results of the comparison reflects a non-acceptability status of a profile characteristic set for a plurality of sets of selection criteria.

5. A system as claimed in claim 1, further comprising a plurality of first clients, wherein the profile characteristic set is compared to a plurality of selection criteria sets, each selection criteria set corresponding to distinct first client, and wherein the report generator generates a writing to the party desirous of participating in the transaction advising the party of at least one selection criterion for each first client that the profile characteristic set failed to satisfy.

6. A method for providing risk control and assessment for transactions on a computer network having a provider computer, a first client computer and a second client computer, wherein the provider computer, the first client computer and the second client computer are in communication therebetween, the method comprising:
predefining a set of factors by the provider computer, wherein the set of factors characterize a type of transaction;
presenting to the first client the predetermined set of factors, wherein the first client transmits data to define factors in the set of factors to create defined selection criteria, wherein the selection criteria represents acceptable parameters of the first client for the transaction;
receiving a profile characteristic set from the second client, wherein the profile characteristic set represents information appurtenant to a party desirous of participating in the transaction; and
comparing the selection criteria to the profile characteristic set to determine whether the profile characteristic set comports with the selection criteria limitations;
providing, from the provider computer to the second client computer, information regarding the results of the comparison determined by the comparison, wherein providing the results of the comparison further comprises providing an acceptability status for the profile characteristic set for the set of selection criteria; and
depending upon the acceptability status, determining whether to request a notice of declination from the provider computer.

7. A method as recited in claim 6, wherein the determination of whether to request a notice of declination is determined subsequent to updating the profile characteristic set in substantially real-time and receiving an updated acceptability status.

8. A method as claimed in claim 6, wherein providing the results of the comparison further comprises providing acceptability status for the profile characteristic set for a plurality of selection criteria sets, wherein each selection criteria set corresponds to a unique first client.

9. A method as claimed in claim 6, wherein the acceptability status is submit for approval or denied.

10. A method for processing of loan applications on a network, having a provider computer, a lender computer and an intermediary computer, wherein the provider computer, the lender computer and the intermediary computer are in communication therebetween, and wherein the provider computer includes a database of defined loan programs, each loan program having a set of predefined lender participation criteria, the method comprising:
preparing a loan application for an applicant desirous of purchasing collateral and desirous of receiving third party funding for the purchase transaction, wherein the intermediary prepares the loan application on behalf of the applicant and wherein the loan application creates an applicant profile;
reviewing, by the intermediary, the applicant profile;
submitting the applicant profile to the provider computer;
receiving, from the provider computer, a first financial analysis of the applicant and a listing of available programs, wherein the listing of available programs includes a preliminary decision as to whether the applicant qualifies for the loan program;
choosing a program and inputting collateral information and loan structure information;
submitting, to the provider computer, the collateral information and the loan structure information in conjunction with the applicant profile;
receiving, from the provider computer, a second financial analysis of the applicant and a second decision as to whether applicant qualifies for the loan program; and
determining whether to request a notice of declination from the provider computer.

11. A method as claimed in claim 10, wherein the determination of whether to request a notice of declination is made from the second client to the provider computer if the second decision is a decline status.

12. A method as claimed in claim 10, wherein the determination of whether to request a notice of declination is made automatically by the provider computer if the second decision is a decline status.
